(19) United States
(12) Patent Application Publication
(10) Pub. No.: US 2015/0172822 A1
(43) Pub. Date: Jun. 18, 2015

(54) LOUDSPEAKER DRIVER WITH DUAL ELECTROMAGNET ASSEMBLIES AND LOUDSPEAKER SYSTEM

(71) Applicant: Cheng Yih Jenq, Piscataway, NJ (US)

(72) Inventor: Cheng Yih Jenq, Piscataway, NJ (US)

(21) Appl. No.: 14/631,673

(22) Filed: Feb. 25, 2015

Related U.S. Application Data
(63) Continuation-in-part of application No. 13/593,736, filed on Aug. 24, 2012.

(51) Int. Cl. H04R 9/06

(52) U.S. Cl. CPC H04R 9/063; H04R 2209/041

(57) ABSTRACT

Loudspeaker drivers are provided. According to one embodiment, a loudspeaker driver comprises a diaphragm, a connection tube, first and second voice coils, and first and second magnet assemblies. The connection tube has a first end section, a second end section, and a middle section. The first voice coil is connected to and surrounds at least a portion of the first end section. The second voice coil is connected to and surrounds at least a portion of the second end section. The first magnet assembly is configured to suspend the first voice coil in a first magnetic field and the second magnet assembly is configured to suspend the second voice coil in a second magnetic field. The connection tube intersects the diaphragm and the middle section of the connection tube is connected to the diaphragm.

### PRIORITY

This application is a continuation-in-part application of U.S. patent application Ser. No. 13/593,736, filed Aug. 24, 2012, the contents of which are hereby incorporated by reference in its entirety.

### TECHNICAL FIELD

The present disclosure relates generally to loudspeaker drivers, and more particularly, to loudspeaker drivers including two electromagnetic structures.

### BACKGROUND

Loudspeakers have been used for years for providing audio output to listeners. Electrical signals that are representative of various characteristics of sounds are transformed by the loudspeakers into vibrating movements of a diaphragm. These movements of the diaphragm create sound waves that can be heard by those nearby. Typically, the diaphragm of the loudspeaker is formed in the shape of a cone and audio waves are emanated from the cone in the general direction where the open end of the cone is pointed.

A loudspeaker typically employs a voice coil that is wrapped around a hollow cylinder or tube, made of such material as paper, aluminum or plastics, and positioned in the magnetic field of a permanent magnet. Also, the hollow cylinder or tube is connected to the diaphragm. When electrical current flows through the coil, a magnetic field is created around the hollow cylinder or tube that may either be attracted to or repelled by the magnetic field of the permanent magnet depending on the direction of the current flow. When the direction of current flow is reversed, the attractive or repulsion forces are also reversed. In this way, the hollow cylinder or tube can be moved back and forth, causing the diaphragm to move back and forth. This vibration creates the sounds that are produced by the loudspeaker.

Typically, high end speaker design is aimed to boost high frequency output, to obtain spatial definition and to enhance the musical resolution. Unfortunately there is a physical obstacle: high frequency sound travels in a narrow path in a sharp cone shaped volume. The higher the frequency the narrower the sound path and the smaller the sharp cone shaped volume. Out of this path and volume, the high frequency diminishes and the sound quality deteriorates.

On the other hand, conventional low frequency drivers are cone diaphragm in shape where the concave side is the front face, facing the audience. The concave cone limits the propagation and dispersion of the sound to a fan shaped zone, which dictates the speaker placement and the audience position.

### SUMMARY

Loudspeaker drivers are described in the present disclosure. According to one embodiment, a loudspeaker driver comprises an acoustical diaphragm, a hollow cylinder or connection tube, first and second voice coils, and first and second magnet assemblies. The connection tube has a first section near a first end of the connection tube, a second section near a second end of the connection tube, and a middle section between the first section and second section. The first voice coil is connected to and surrounds at least a portion of the first section of the connection tube. The first voice coil has a first audio lead and a second audio lead. The second voice coil is connected to and surrounds at least a portion of the second section of the connection tube. The second voice coil has a first audio lead and a second audio lead. The first magnet assembly is configured to suspend the first voice coil in a first magnetic field and the second magnet assembly is configured to suspend the second voice coil in a second magnetic field. The connection tube intersects the acoustical diaphragm and the middle section of the connection tube is connected to the acoustical diaphragm.

According to another aspect of the present disclosure, a loudspeaker assembly is provided. The speaker assembly includes a first speaker including: a first frustoconical frame section configured to support a first acoustical diaphragm; a first voice coil coupled to the first acoustical diaphragm, the first voice coil having a first positive audio lead and a second negative audio lead; and a first magnet assembly configured to suspend the first voice coil in a first magnetic field, the first magnet assembly coupled to the first frustoconical frame section. The loudspeaker assembly further includes a second speaker including: a second frustoconical frame section configured to support a second acoustical diaphragm; a second voice coil coupled to the second acoustical diaphragm, the second voice coil having a first positive audio lead and a second negative audio lead; and a second magnet assembly configured to suspend the second voice coil in a second magnetic field, the second magnet assembly coupled to the second frustoconical frame section. An audio signal driver electrically is coupled to each of the first and second voice coils, wherein the first and second voice coils are wired in opposite polarity such that the first and second acoustical diaphragms vibrate in unison. In one aspect, the first and second speakers are arranged with a wide end of the first and second frustoconical frame sections respectively facing each other.

### BRIEF DESCRIPTION OF THE DRAWING

The above and other aspects, features, and advantages of the present disclosure will become more apparent in light of the following detailed description when taken in conjunction with the accompanying drawings.

FIG. 1 is a side view of a loudspeaker driver, according to various implementations of the present disclosure;

FIG. 2 is a cutaway view of the loudspeaker driver of FIG. 1, according to various implementations of the present disclosure;

FIG. 3 is a cutaway view of a speaker assembly, according to various implementations of the present disclosure;

FIG. 4 is a three-dimensional (3D) view of a speaker system in accordance with the present disclosure;

FIG. 5A illustrates a line of axis of a driver;

FIG. 5B illustrates a high frequency propagation pattern of a sound wave and FIG. 5C illustrates a low frequency propagation pattern of a sound wave along the line of axis of a driver;

FIG. 6 is a cross sectional view of the speaker system shown in FIG. 4 in accordance with an embodiment of the present disclosure;

FIG. 7 is a cross sectional view of a speaker system in accordance with another embodiment of the present disclosure;

FIG. 8 is a 3D view of another embodiment of a speaker system in accordance with the present disclosure;

FIG. 9 illustrates a stereo speaker system in accordance with an embodiment of the present disclosure; and

FIG. 10 illustrates a surround sound speaker system in accordance with the an embodiment of the present disclosure.

To facilitate understanding, identical reference numerals have been used wherever possible to designate identical elements that are common to the figures. The images in the drawings are simplified for illustrative purposes and are not necessarily drawn to scale. The appended drawings illustrate exemplary embodiments of the present disclosure and, as such, should not be considered as limiting the scope of the disclosure that may admit to other equally effective embodiments. Correspondingly, it has been contemplated that features or steps of one embodiment may beneficially be incorporated in other embodiments without further recitation.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

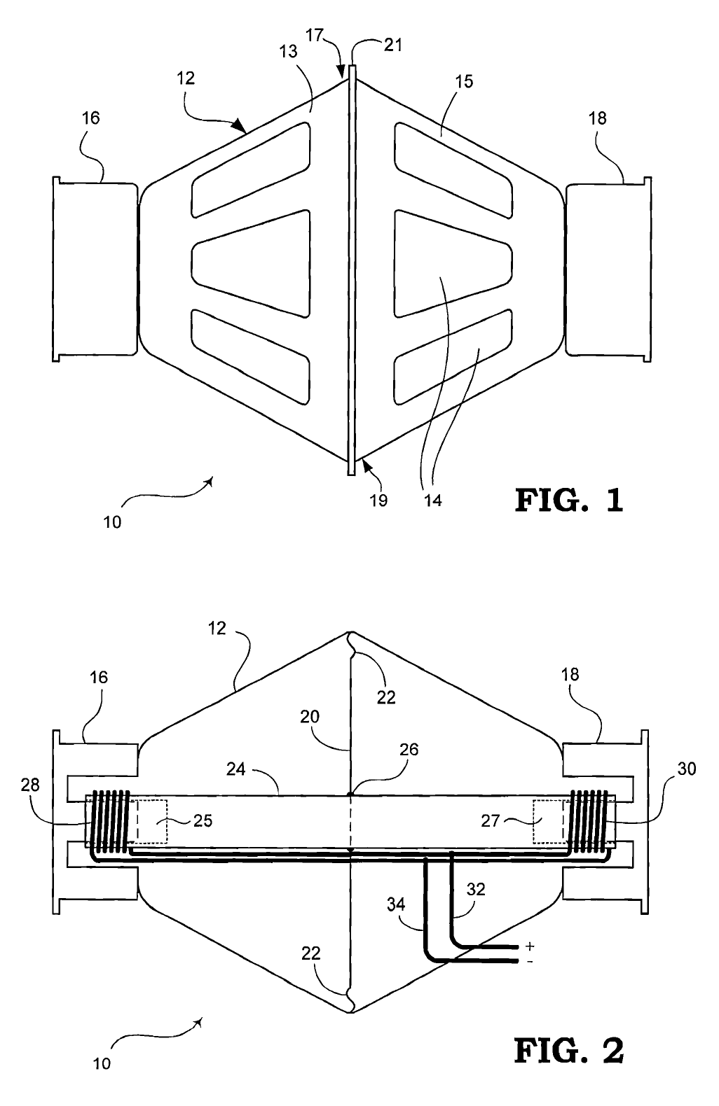

FIG. 1 is a side view of an embodiment of a loudspeaker driver 10. According to various implementations of the present disclosure, the loudspeaker driver 10 comprises a frame 12 having holes 14 or apertures. Since the frame 12 surrounds and protects the internal components of the loudspeaker driver 10, particular the components that generate sound, the holes 14 allow the audio waves to escape in numerous directions. In this respect, the loudspeaker driver 10 described in the present disclosure may be referred to as an omni-directional speaker. As illustrated, the frame 12 may comprise two symmetrical sections 13, 15, such as, for example, frustoconical sections. These two sections 13, 15 may be arranged with their wide ends 17, 19 respectively facing each other and connected to each other along barrier 21, as shown. In other embodiments, the frame 12 may include any other suitable shape. Also, the frame 12 may be configured with any suitable size, depending on size limitations and/or desired frequency response characteristics. The loudspeaker driver 10 also includes a first magnet assembly 16 and a second magnet assembly 18. Each magnet assembly 16 and 18 may include at least one permanent magnet for creating a magnetic field. The magnetic fields created by the first and second magnet assemblies 16 and 18 may be arranged such that the north and south poles are aligned (attracting), or, in alternative embodiments, the magnetic fields may be arranged such that the north and south poles thereof are opposed (repelling).

FIG. 2 is a cutaway view of the loudspeaker driver 10 of FIG. 1. According to various implementations of the present disclosure, the loudspeaker 10 further comprises a diaphragm 20 or other type of membrane. It should be noted that the diaphragm 20 may comprise any suitable material. The diaphragm 20 may be planar and held in a substantially vertical position, as shown. The diaphragm 20 may be connected to the frame 12 by a suspension 22. In some embodiments, the suspension 22 may be omitted and the diaphragm 20 may instead be connected directed to the frame 12. The suspension 22, when present in various embodiments, may be a ring suspension that surrounds the outside edge of the diaphragm 20. The suspension 22 holds the diaphragm 20 in place and allows the diaphragm 20 to vibrate for the purpose of creating audio waves. It should be noted that because of the particular structure of the substantially planar diaphragm 20 instead of a conventional cone-shaped membrane, the suspension 22 is sufficient to support the diaphragm 20 without the need for additional suspension mechanisms, such as “spider” suspension elements.

The loudspeaker driver 10 also comprises a connection tube 24, which spans from the first magnet assembly 16 to the second magnet assembly 18. The connection tube 24 may be made of such material as paper, aluminum, plastics, etc. In some embodiments, the connection tube 24 may include hollow ends. In this way, the connection tube 24 can be kept in place by a post 25, 27 protruding from each of the magnet assemblies 16, 18, respectively. The connection tube 24 may be configured to slide along the posts 25, 27. Slits may be formed in the sides of the posts and inside portions of the connection tube 24 in order to prevent air pockets from forming in the hollow ends.

It is to be appreciated that the connection tube 24 may take other forms, for example, as a connection member, cylindrical solid member, a rod, etc.

The connection tube 24 is inserted through a hole in the diaphragm 20. In some embodiments, half of the connection tube 24 may be positioned on one side of the diaphragm 20 while the other half is positioned on the other side. Also, the connection tube 24 may be arranged such that its axis is perpendicular to the plane of the diaphragm 20. In addition, the connection tube 24 may protrude through or intersect the center of the diaphragm 20. The connection tube 24 is also configured to be coupled to the diaphragm 20 at an intersecting area, and may be adhered to the diaphragm 20 by any suitable type of adhesive 26 at the intersecting area. According to some embodiments, the adhesive 26 may be a bead of glue, or other suitable adhesive material, which may be formed in a ring around the outside of the connection tube 24.

In addition, the loudspeaker driver 10 comprises a first voice coil 28 and a second voice coil 30. The first and second voice coils 28 and 30 comprise electrical wires with insulation material surrounding the wires. The first voice coil 28 is wound around a first end of the connection tube 24 and the second voice coil 30 is wound around a second end of the connection tube 24. Not only are the voice coils 28 and 30 wrapped around the connection tube 24, but they are also connected to the connection tube 24 such that movement of the voice coils 28 and 30 due to magnetic forces in turn provides movement of the connection tube 24.

As shown, the voice coils 28 and 30 may be wound in the same direction. However, in other embodiments, the voice coils 28 and 30 may be wound in opposite directions from each other. One end of each of the voice coils 28 and 30 is coupled to a first audio lead 32, which is designated as a positive (“+”) lead. The other end of each of the voice coils 28 and 30 is coupled to a second audio lead 34, which is designated as a negative (“−”) lead. The positive and negative leads may also be referred to by the color of their electrical wires, such as black and red leads. As shown, an audio lead from one voice coil is connected to a specific audio lead from the other voice coil. However, according to some embodiments, the audio lead from the one voice coil may be connected to the other audio lead from the other voice coil. The specific design depends primarily on the orientation of the poles (i.e., north pole and south pole) of the two magnetic fields generated by the permanent magnets of the first and second magnet assemblies 16 and 18.

The magnet assemblies 16 and 18 may each comprise one or more permanent magnets arranged to create a permanent magnetic field in a general direction with respect to the ends of the connection tube 24. For example, according to some embodiments, the permanent magnets may be ring magnets that surround the voice coils 28 and 30. In other embodiments, the permanent magnets may include other shapes and may be positioned along the axis of the connection tube 24. These or other arrangements may be used for creating a permanent magnetic field in a general direction with respect to a center point of the voice coils 28 and 30.

According to some embodiments, the loudspeaker driver 10 may simply comprise the acoustical diaphragm 20 and the connection tube 24 as shown in FIG. 2. The connection tube 24 may have a first section near a first end of the connection tube 24, a second section near a second end of the connection tube 24, and a middle section between the first section and second section. The loudspeaker driver 10 also includes the first voice coil 28 connected to and surrounding at least a portion of the first section of the connection tube 24, wherein the first voice coil 28 has a first audio lead and a second audio lead. The loudspeaker driver 10 also includes the second voice coil 30 connected to and surrounding at least a portion of the second section of the connection tube 24, wherein the second voice coil 30 has a first audio lead and a second audio lead. The loudspeaker driver 10 also includes the first magnet assembly 16 configured to suspend the first voice coil 28 in a first magnetic field and the second magnet assembly 18 configured to suspend the second voice coil 30 in a second magnetic field. The connection tube 24 intersects the acoustical diaphragm 20 and the middle section of the connection tube 24 is connected to the acoustical diaphragm 20.

According to additional embodiments, the loudspeaker driver 10 described above may be further configured such that the first magnet assembly 16 comprises a first permanent magnet and the second magnet assembly 18 comprises a second permanent magnet. For example, the first permanent magnet may be a ring magnet positioned around the first voice coil 28 and the second permanent magnet may be a ring magnet positioned around the second voice coil 30. The first magnet assembly 16 and second magnet assembly 18 may comprise alignment structures configured to enable the connection tube 24 to move along a substantially axial direction. For example, the axial direction may be defined as the direction of the axis of the connection tube 24. The loudspeaker driver 10 may further be defined such that the first voice coil 28 and second voice coil 30 are configured to simultaneously receive electrical signals causing the first voice coil 28 and second voice coil 30 to create cooperative forces on the connection tube 24, thereby causing the connection tube 24 to move back and forth along the substantially axial direction.

According to some embodiments, the loudspeaker driver 10 described above may further be defined such that the acoustical diaphragm 20 is substantially planar when at rest. For example, the acoustical diaphragm 20 may be at rest when there are no electrical signals provided to the loudspeaker driver 10. When electrical signals (e.g., audio signals) are received, the diaphragm 20 will vibrate in a way that causes sound waves to be radiated from the loudspeaker driver 10. In some implementations, the acoustical diaphragm 20 may have a circular shape, but according to other implementations, the diaphragm 20 may be square, rectangular, or any other suitable shape.

Furthermore, the loudspeaker driver 10 also comprises the frame 12, wherein the frame 12 may be configured to support the first magnet assembly 16 and second magnet assembly 18 and maintain a predetermined distance between them. Also, the loudspeaker driver 10 may comprise the suspension 22 (e.g., a ring suspension) configured to connect an edge of the acoustical diaphragm 20 with the frame 12. The suspension 22 may have any suitable shape depending on the corresponding shape or edge dimensions of the diaphragm 20. Also, the shape of the suspension 22 may also depend on the inside dimensions and shape of the frame 12. The frame 12 preferably comprises at least one hole 14 to expose the acoustical diaphragm 20 to the environment. The holes 14 allow the sound to radiate from the interior of the frame 12 out into the surrounding areas where listeners may hear the sound.

In addition, the loudspeaker driver is further defined such that the first audio lead of the first voice coil 28 is coupled to the first audio lead of the second voice coil 30 and the second audio lead of the first voice coil 28 is coupled to the second audio lead of the second voice coil 30. In this respect, the poles of the first magnetic field will be substantially aligned with poles of the second magnetic field. Therefore, the first voice coil 28 will provide a pushing force on the diaphragm 20 while the second voice coil 30 provides a pulling force, and the first voice coil 28 will provide a pulling force while the second voice coil 30 provides a pushing force. The forces in this case will be additive for moving the connection tube 24 in the same direction without the voice coils 28 and 30 working against each other.

In other embodiments, the first voice coil 28 and second voice coil 30 may be wound in the same direction around the connection tube 24, and the poles of the first magnetic field will be substantially opposed to poles of the second magnetic field. In other words the north poles will both be on the inside (or outside) and the south poles will both be on the outside (or inside). In this case, the first voice coil 28 and second voice coil 30 will be wound in opposite directions around the connection tube. Again, this arrangement also results in the forces being additive, such that the voice coils 28 and 30 will not be working against each other.

With two electromagnetic structures, as described herein, the force exerted on the diaphragm 20 can essentially be doubled. For instance, at any instance in the electrical signals, one voice coil provides a pushing force (i.e., toward a center region of the frame 12) on the connection tube 24 while the other voice coil provides a pulling force (i.e., away from the center region of the frame 12) on the connection tube 24. The result is a quick response and quick movement of the diaphragm 20, which increases the dynamic range of the loudspeaker driver 10. Since the diaphragm moves at high acceleration by both pull and push forces, the diaphragm transfers more effective power to the air in creating sound, i.e., high efficiency in power conversion of electricity to sound energy. Also, the dual push/pull voice coils can extend both the high and low frequency responses of the loudspeaker driver 10.

Furthermore, the symmetrical aspects of the loudspeaker driver 10 described in the present disclosure allow for better control of the diaphragm 20 thereby resulting in more accurate reproduction of audio signals. By providing push-pull forces on the diaphragm, the diaphragm's vibration more precisely follows the sound electrical signal, resulting in a higher definition sound reproduction than conventional drivers.

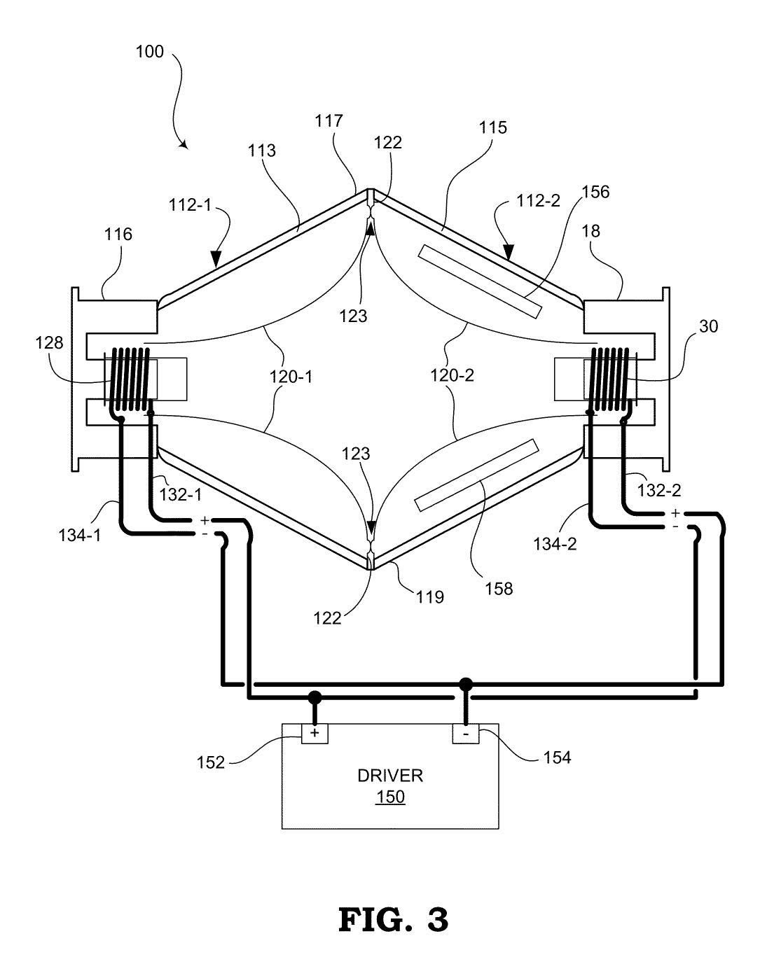

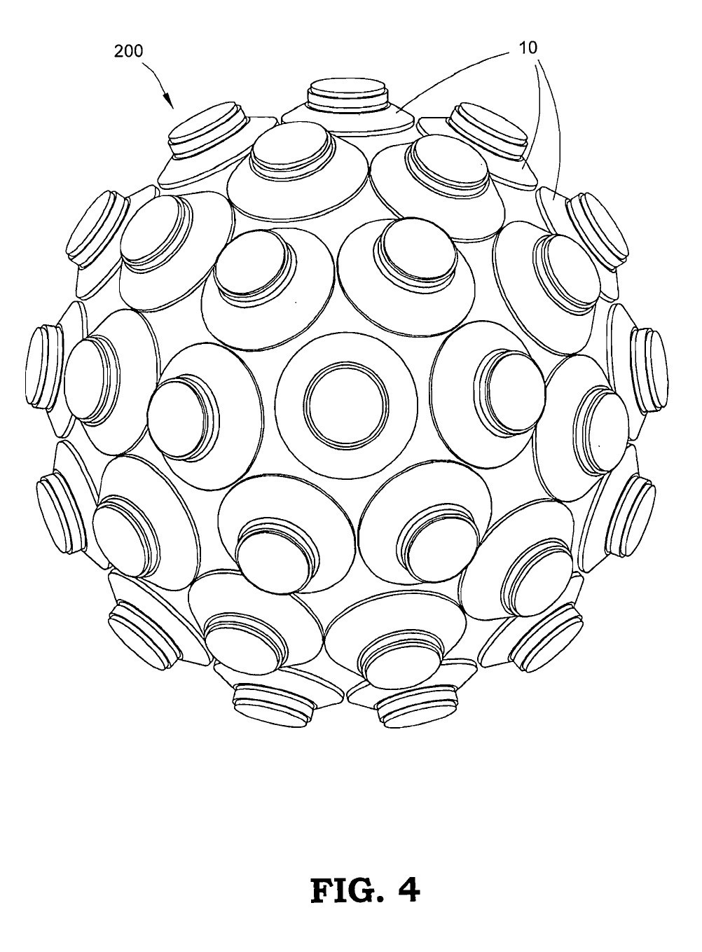

The teachings and principles of the present disclosure may be configured in various implementations to achieve a loudspeaker with increased dynamic range. In one embodiment, two conventional speakers may be coupled mouth to mouth, or, diaphragm to diaphragm, and wired in opposite polarity, such that the two diaphragm vibrates in unison. In such an embodiment, the two diaphragms simulate a single diaphragm. Such an implementation is illustrated in FIG. 3.

Referring to FIG. 3, speaker assembly 100 includes a first and second speakers 112-1, 112-2. The first speaker 112-1 includes a frustoconical frame section 113 with a cone-shaped or frustoconical diaphragm 120-1 coupled to the frame section 113 by a suspension 122. The first speaker 112-1 further includes a magnet assembly 116 and a voice coil 128, as described above. Likewise, the second speaker 112-2 includes a frustoconical frame section 115 with a cone-shaped or frustoconical diaphragm 120-2 coupled to the frame section 115 by a suspension 122, a magnet assembly 118 and a voice coil 130. The first and second speakers are arranged with the wide ends 117, 119 of the frame sections 113, 115 respectively facing each other and so at least a portion of each diaphragm 120-1, 120-2 contact with each other, for example, at portion 123. It is to be appreciated that since each diaphragm 120-1, 120-2 has a cone or frustoconical shape, portion 123 is circular, and therefore, diaphragms 120-1, 120-2 come into contact with each other in a circular manner. For example, diaphragms 120-1, 120-2 may be coupled to each other at portion 123 by glue, or other means for retaining the contact surfaces of portion 123 together. In other embodiments, the diaphragm 120-1, 120-2 do not touch each other.

Speaker assembly 100 further includes an audio signal driver 150 for electrically driving the voice coils 128, 130 which includes a positive output 152 and a negative output 154. Exemplary audio signal drivers include an audio amplifier, receiver, etc., or any other known device for providing an electrical signal indicative of an audio signal. Each of the voice coils 128, 130 include a positive audio lead 132 and a negative audio lead 134. In this embodiment, the voice coils 128, 132 are wired in opposite polarity, such that the two diaphragm vibrates in unison. For example, positive audio lead 132-1 of voice coil 128 is connected to the positive output 152 of driver 150, while positive audio lead 132-2 of voice coil 130 is connected to the negative output 154 of driver 150. Similarly, negative audio lead 134-1 of voice coil 128 is connected to the negative output 154 of driver 150, while negative audio lead 134-2 of voice coil 130 is connected to the positive output 152 of driver 150. In this respect, the first voice coil 128 will provide a pushing force on the diaphragm 120-1 while the second voice coil 130 provides a pulling force on the diaphragm 120-2, and the first voice coil 128 will provide a pulling force while the second voice coil 130 provides a pushing force. In this manner, the two diaphragms 120-1, 120-2 vibrate in unison and simulate a single diaphragm. Since the two diaphragms 120-1, 120-2 are convex-side outward facing, when they vibrate in unison, the sound propagation pattern is nearly 360 degrees, i.e., omni-directional.

In one embodiment, at least one of the diaphragms has an opening or slot to reduce the weight of the diaphragm and to dissipate air pressure exerted between the two diaphragms. Referring to FIG. 3, diaphragm 120-2 includes at least one slot 156, 158. In this embodiment, the speaker 112-1 is considered the primary speaker responsible for sound generation while the speaker 112-2 is considered the secondary speaker which allows dissipation of air pressure through slots 156, 158 and subsequently through holes 14 of the frame.

In another embodiment, a woofer-less and box-less loudspeaker system including a plurality of drivers and a method of driver placement are provided. In this embodiment, the loudspeaker system uses multiple drivers as described above to create a space of sound wave where high frequencies are evenly spaced, by angularly equal distance placement of the drivers, while the low frequencies are reinforced by each other tweeter drivers' output. The placement of the drivers can be almost anywhere except their angles are important, that is, the placement is concentric and evenly dispersed in angle. The configuration of the drivers are three dimensional, and therefore, the resultant shape and form could be cubical, planar, spherical, cylindrical, etc.

Referring to FIG. 4, a three-dimensional (3D) view of a speaker system 200 in accordance with the present disclosure is illustrated. The speaker system 200 includes a plurality of drivers 10, such as those described above in relation to FIGS. 1-3, arranged in a three-dimensional spherical configuration.

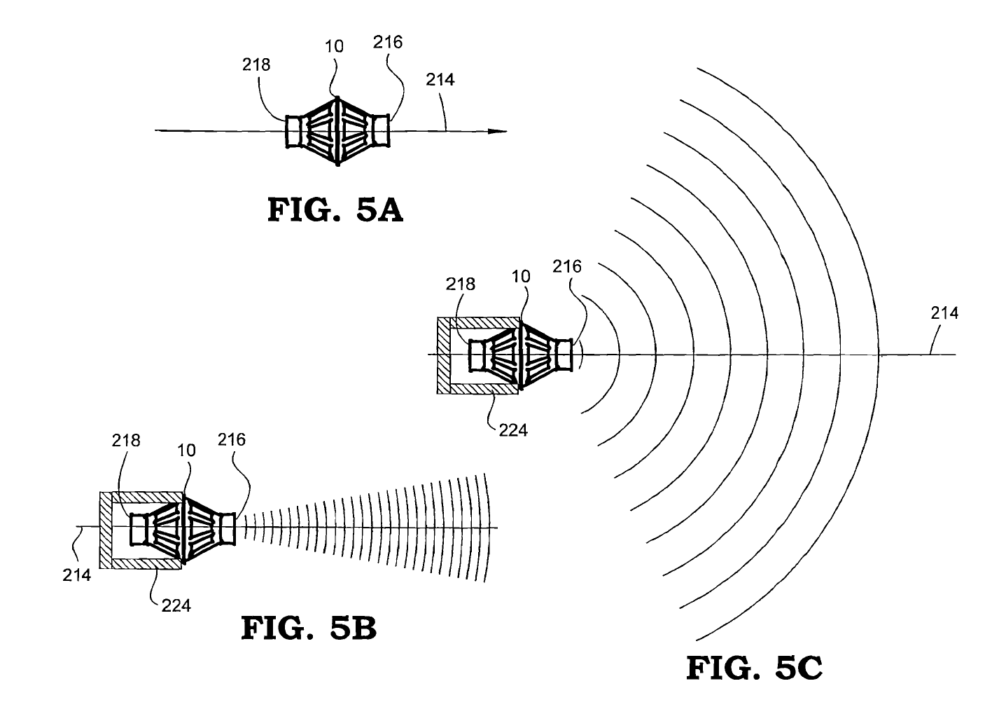

Referring to FIG. 5A, for each driver 10, there is an imaginary line of axis 214 which is the line of geometrical symmetry. Each driver 10 include a front face or surface 216 and a rear or back surface 218. This imaginary line of axis 214 extends in both direction from the rear surface 218 through the front surface 216 of the driver 10. Since the driver's diaphragm has its motion along this line of axis 214, this line of axis also represent the direction of the propagation of the sound wave, which generally propagates from the front face 216 of the driver along this axis 214. FIG. 5B illustrates a high frequency propagation pattern and FIG. 5C illustrates a low frequency propagation pattern for driver 212 along the line of axis 214. In this embodiment, a sealer or muffler 224 is added to the rear or back side of the driver 10 to prevent the front emitting and back emitting frequencies from interfering with each other.

Various support structures may be configured to support multiple drivers 10. The drivers 10 may be arranged in space relative to one another such that the axes of symmetry extending from the front face of the drivers intersect at one point in space at the center of an inner volume of the support structure. In some embodiments, the axes of symmetry may pass through a relatively small volume at or near the center of the inner volume. The drivers 10 may be spread out evenly around the inner volume toward which the faces of the drivers 10 are directed. When the drivers 10 are distributed evenly, the angles between their axes of symmetry may be substantially equal. In this arrangement, the sound waves emanating from the drivers 10 are directed inwardly toward the center of the support structure.

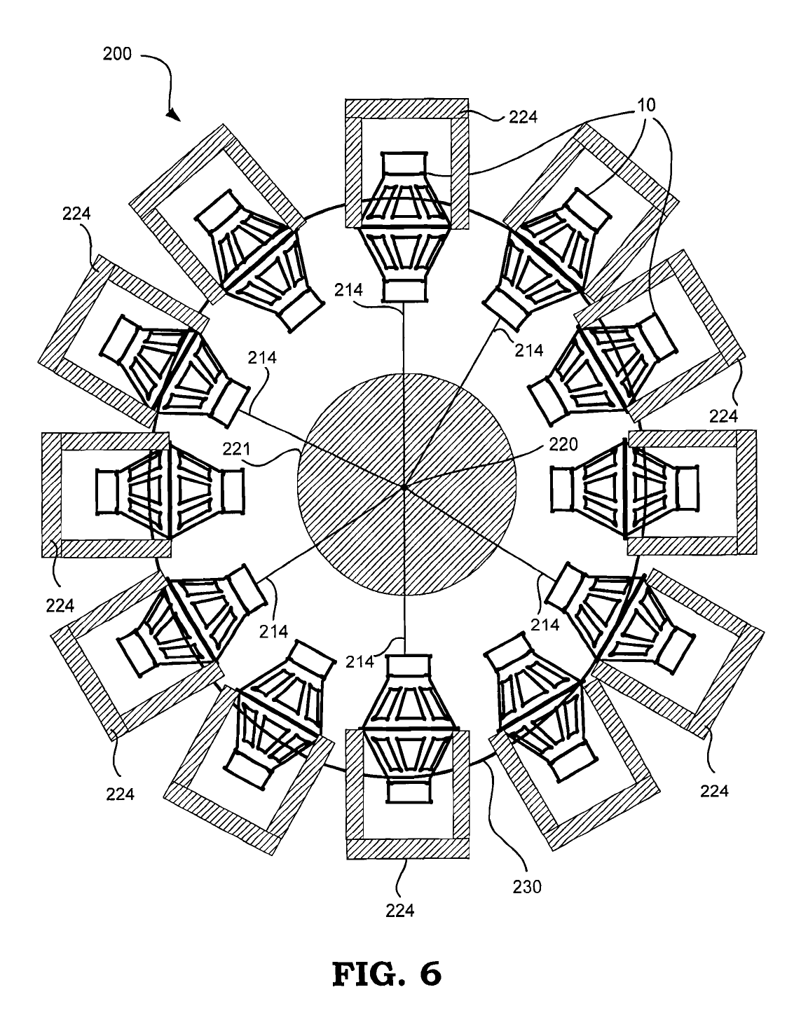

FIG. 6 illustrates a cross sectional view of the speaker system 200 shown in FIG. 4. As shown in FIG. 6, the drivers 10 are arranged on a support structure 230 such that the lines of axis 214 of each driver 10 forward converge at a single point in space 220. In this embodiment, the drivers are equidistant from the point of convergence 220. Although all drivers, preferably, share one common point of origination and convergence of the lines of axis, the distance of the drivers to this point does not have to be the same, i.e., various drivers may be placed at different distances from the point of convergence. As a result, the drivers placement are flexible to form planar, cylindrical, cubical, spiral or spherical shapes. For example, in one embodiment, a configuration where the drivers are arranged in an oval or convex shape may be provided. In this embodiment, each driver is arranged at a different angle relative to the other drivers while ensuring the forward converge of each drivers' line of axis 214 converge at a single point 220.

Referring back to FIG. 6, the drivers 10 are arranged such that the axes of symmetry 214 of each driver 10 converge at a single point in space 220. In some embodiments, the drivers 10 may be arranged at substantially equal distances from the single point 220. With such an arrangement, the general lines of propagation of the sound waves emanating from the drivers 10 are focused on the common point 220. From the common point 220, the sound waves continue to propagate through gaps formed between the drivers 10. In this way, the sound wave is evenly distributed to area outside the inner volume of the support structure 230 and there are no concentration points in the listening area. By providing such an arrangement, the drivers provide low frequency reinforcement that can reach a listener whether the drivers are aim at the listener or not.

The louder speaker system constructed as above consists of no mid-range driver and of no woofer driver. Furthermore, the louder speaker system constructed as above consists of no box and/or enclosure, which are commonly employed in a conventional speaker. Conventional speaker drivers are mounted on a closed box and such an arrangement is in effect a “drum”, which imparts its characteristic resonance to the sound material. Although the drivers 10 are assembled on some type of support structure 230, the structure 230 is minimal to support the drivers but will not alter or effect the sound quality of the speaker system. In one embodiment, the support structure 230 is configured from a wire frame. The wire frame will support the drivers without any coloration to the sound produced by the speaker system. It is to be appreciated that other support structures configured from various known materials may be employed to arrange the drivers in accordance with the teachings of the present disclosure. For example, the support structure may be configured as a tree-like structure, a honey comb structure with a hollow core, etc. In the speaker system in accordance with the principles of the present disclosure, the sound coloration as a result of the resonance of the box or enclosure is therefore completely eliminated.

Additionally, an inert muffling or baffle ball 221 may be disposed in the inner volume of the support structure to reduce resonance. Preferably, the ball 221 is made from a material that is inert to sound frequency such as plaster, styrene foam, cement, or any other material that does not resonant to any sound frequency.

By employing the principles of the present disclosure, several advantages can be achieved.

1. The speaker system in this invention can be configured as a ball shape, a column, a pyramid, a thin panel, an oval, and so on.
2. The speaker system is free of placement restriction. For example, as shown in FIG. 4, the speaker system is configured as a three dimensional spherical object emitting sound waves in all directions in space, equally in all directions, and is therefore called omni-directional. There is no restriction to the relative position of a listener to the speaker system, and vice versa.
3. The speaker system will sound the same regardless of the listener's relative position, whether sitting, standing, or moving about.
4. The speaker system is free of the woofer's and the box's coloration of the sound.
5. The speaker system is compact and has a small footprint, making it ideal for a narrow space such as in a car. In a further example, the speaker system shown in FIG. 4 can be mounted on a pedestal, where the footprint of the system is the base of the pedestal which can be relatively small.

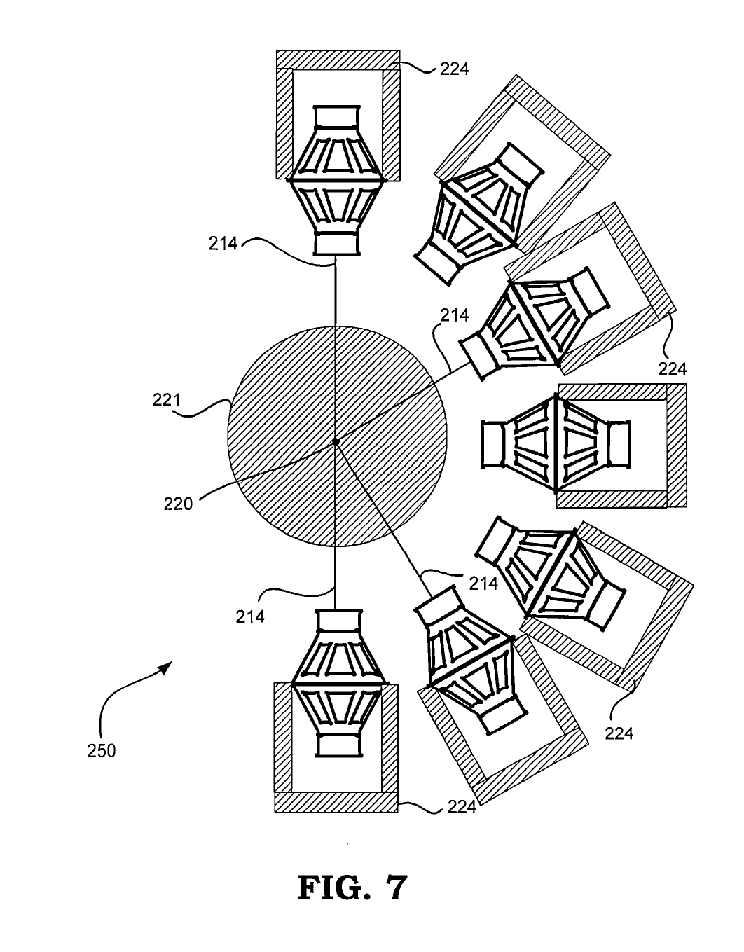

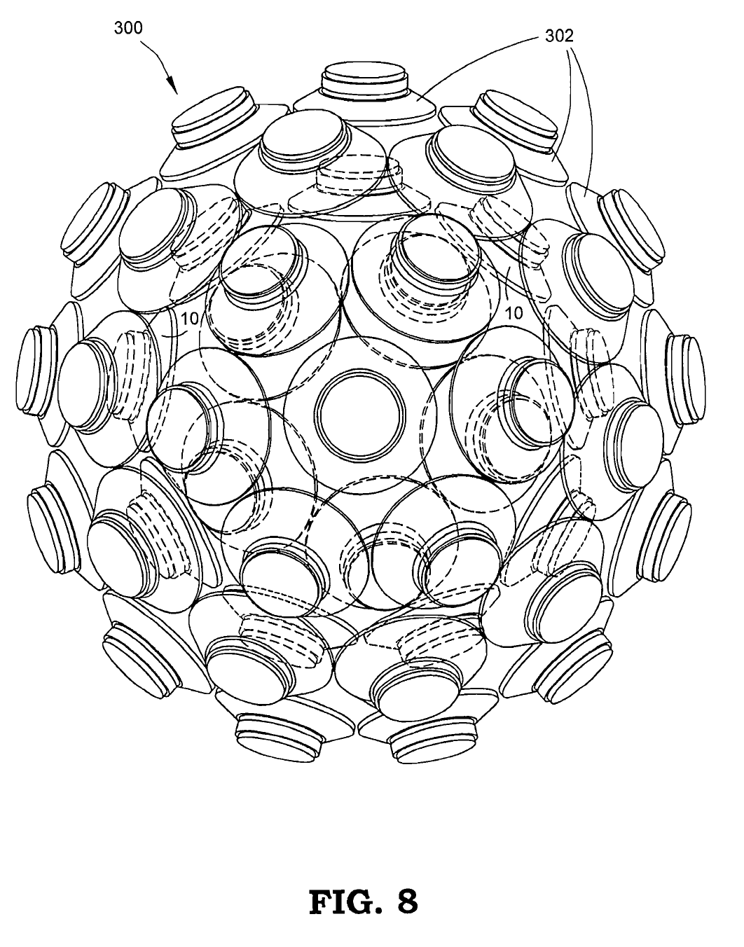

Although ideally the speaker system is a three dimensional cluster of drivers, in some embodiments, the rear half of the cluster may be removed, leaving only the frontal half of the cluster, as illustrated in FIG. 7, where FIG. 7 is a hemisphere configuration 250. The result is the sound quality, especially the low frequency portion or bass of the sound, is compromised, since some of the bass sound contributed from the rear half of the cluster is no longer available. In the listening area where the frontal half of the cluster is facing, the high frequency portion of the sound would be relatively too intense due to the reduced intensity of the low frequency. To correct this, an inert muffling ball 221 is placed in front of some of the drivers 10 to reduce the intensity of the high frequency portion of the sound, since it will be reflected backward. Preferably, the ball 221 is made from a material that is inert to sound frequency such as plaster, styrene foam, cement, or any other material that does not resonant to any sound frequency.

According to some embodiments, the general shape of the drivers 10 from a front view may be circular or oval. It should be recognized that arranging circular or oval drivers 10 in three dimensions around an inner volume will result in gaps between the drivers 10, regardless of how closely they are positioned. Many of the sound waves directed toward the inner volume are thus able to emanate through the gaps to the space outside the arrangement of drivers 10. Therefore, the listening area is intended to be outside the loudspeaker system and the audio signals will seem to emanate from a single point source, which is at or near the center point 220.

Although the drivers 10 share one common point of origination and convergence of the axes of symmetry according to the embodiment of FIG. 6, the distance of the drivers 10 to the point 220 does not have to be the same. That is, various drivers 10 may be placed at different distances from the point of convergence 220. As a result, the driver placement may be flexible in some embodiments so as to form planar, cylindrical, cubical, spiral or spherical shapes, among others. For example, the drivers 10 may be arranged in an oval or convex shape. In this embodiment, each driver is arranged at a different angle relative to the other drivers while ensuring the intersection of each driver's axis of symmetry with a common point. In some embodiments, the axes of symmetry 214 may intersect with a relatively small volume, elongated volume, or line segment at or near the point 220 at the center of the arrangement of drivers 10 and support structure.

The speaker systems 200 and 250 of FIGS. 4 and 7 may be constructed to contain only tweeters and no mid-range drivers or woofer drivers. Furthermore, the speaker systems 200, 250 may be constructed without boxes and/or enclosures, which are commonly employed in conventional speaker systems. Conventional speaker drivers are normally mounted on the surfaces of a closed box with the diaphragms facing outward to project the sound waves in a generally linear fashion, as mentioned above. The conventional speaker box therefore imparts its characteristic resonance to the sound waves to significantly alter the sound quality. According to the various implementations of the present disclosure, the drivers 10 are fixedly mounted on a support structure that has little, if any, effect on the sound quality of the speaker systems 200, 250. The support structure may include minimal materials for supporting the drivers 10 to reduce or even completely eliminate the sound coloration as a result of the resonance of a box or enclosure.

In one embodiment, the support structure may be configured as a wire frame. The wire frame will support the drivers without any effect or coloration to the sound produced by the speaker system. It is to be appreciated that other support structures configured from various known materials may be employed to arrange the drivers in accordance with the teachings of the present disclosure. For example, the support structure may be configured as a tree-like structure, a honey comb structure with a hollow core, etc.

In another embodiment, in order to extend the bass performance of the loudspeaker system, the loudspeaker system will employ woofer drivers, where a sphere of woofer drivers is disposed concentrically about the sphere of drivers. Referring to FIG. 8, a 3D view of this embodiment of in accordance with the present disclosure is illustrated as speaker system 300. In this embodiment, a driver cluster is arranged in an inward facing and spherical configuration, complemented by a woofer driver cluster also arranged in an inward facing and spherical configuration which is disposed about the driver cluster. It is to be appreciated that the woofer drivers employed are conventional woofer drivers known in the art to produce low frequency sounds, typically from around 40 hertz up to about a kilohertz or higher. Each spherical cluster may be powered separately and speaker system 300 may perform as a two-way speaker system.

In FIG. 8, the tweeter sphere includes a plurality of drivers 10 and is shown in broken lines within an outer sphere consisting of a plurality of woofers 302 surrounding the inner driver sphere. The inner tweeter sphere and the outer woofer sphere are concentric and share a common focal point is space. It is to be appreciated that the woofer drivers 302 may be arranged in various configurations relative to the inner drivers 10. For example, in one embodiment, the woofer drivers 302 may be arranged directly behind a tweeter driver 10 to deflect emanating sound waves. In another embodiment, each woofer driver 302 may be arranged so the axis of symmetry will pass through a gap in the arrangement of tweeter drivers to the central point.

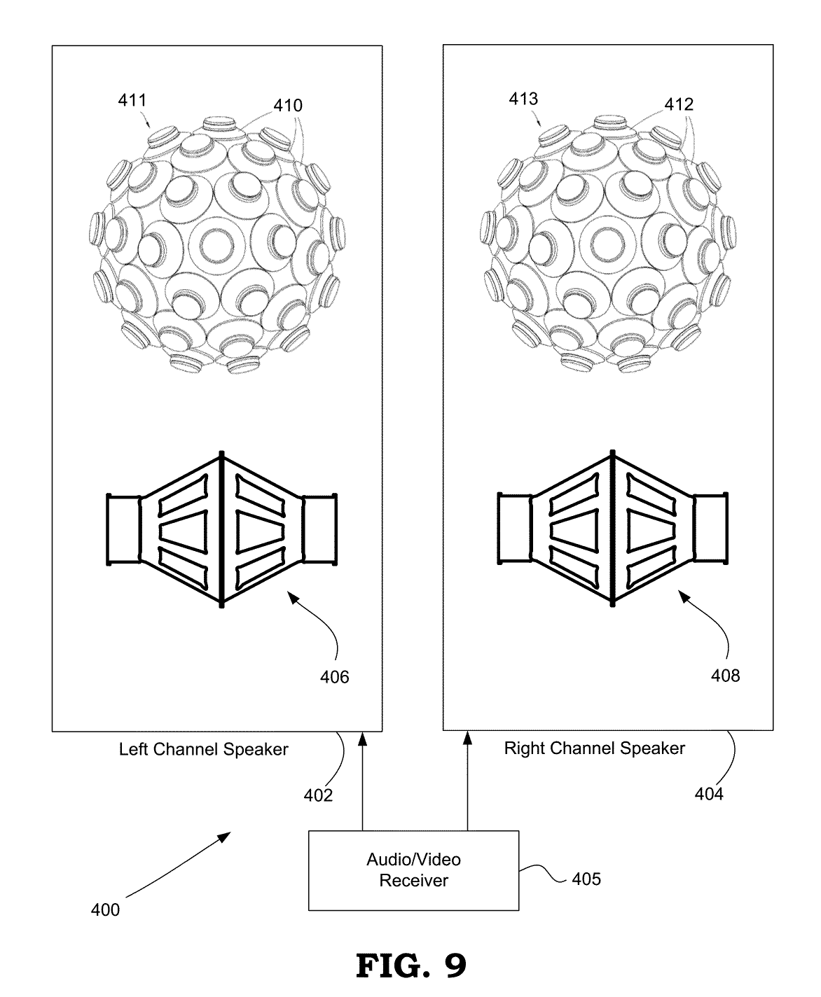

It is to be appreciated that the drivers and speakers of the present disclosure may be employed in various speaker assemblies and various speaker system configurations. For example, in one embodiment, the drivers 10, 100 of the present disclosure may be employed in a stereo speaker system 400 as illustrated in FIG. 9. The stereo speaker system 400 includes a left channel speaker 402, a right channel speaker 404 and a audio/video (A/V) receiver 405. Each of the left and right channel speakers 402, 404 includes a dual magnetic driver 406, 408 respectively and at least one tweeter 410, 412 respectively. The dual magnetic drivers 406, 408 may be configured in accordance with any of the above-described embodiments. It is to be appreciated that the dual magnetic drivers 406, 408 will act as a low frequency driver while the at least one tweeter will act as a high frequency driver. The receiver 405 provides an audio signal to the dual magnetic drivers 406, 408 and the at least one tweeter 410, 412 via either series or parallel wiring.

The at least one tweeter 410, 412 may be configured as an inward firing tweeter cluster 411, 413 as shown and described in commonly owned U.S. Pat. No. 8,917,881, the contents of which are incorporated by reference in its entirety. U.S. Pat. No. 8,917,881 describes an inward firing tweeter cluster which includes multiple tweeters placed on the circumference of a sphere, or part of the sphere, with the tweeters' diaphragm side facing inward such that every tweeter is: equal distance to, as well as aiming at, the center point of the sphere. In such arrangement, the center lines of symmetry of the tweeters and their sound direction of propagation, are converging at and running through the center of radius of the sphere. The result of said tweeter cluster, when excited with a sound signal, is to beam sound waves aiming at the center of radius of the sphere. The beamed sound waves converge, collide, re-combine, and re-emit in all directions, independent of each incoming sound wave's original orientation. The point of center of radius of the sphere therefore becomes an virtual omni directional, phantom tweeter which emits sound waves propagating in all directions, that is, 360 degrees in three dimensions.

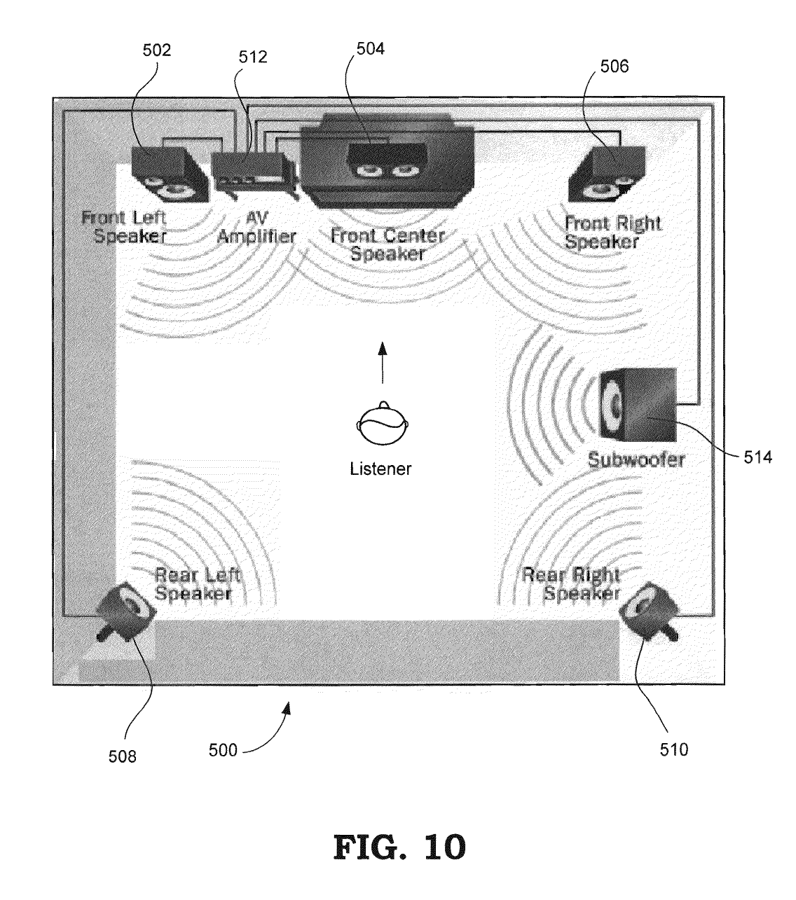

In another embodiment, the drivers 10, 100 of the present disclosure may be employed in a surround sound speaker system 500 as illustrated in FIG. 10. The surround sound speaker system 500 includes front left (channel) speaker 502, front center (channel) speaker 504, front right (channel) speaker 506, rear left (channel) speaker 508 and rear right (channel) speaker 510. The system 500 further includes a audio/video (A/V) receiver/amplifier 512 for receiving audio and/or video signals and providing the signals to speakers 502, 504, 506, 508, 510 and woofer 514. Although a 5.1 surround sound system is illustrated other configurations are contemplated to be with in the scope of the present disclosure, for example, 6.1 and 7.1 surround sound systems, named for the number of channels or speakers. The “0.1” indicates a channel for the subwoofer 514. The subwoofer channel carries low-frequency sound to give a bass boost and create a rumbling effect for certain special effects sounds. In one embodiment, any one of the illustrated speakers 502, 504, 506, 508, 510 may employ the dual magnetic drivers 10, 100 as described above. In another embodiment, any one of the illustrated speakers 502, 504, 506, 508, 510 may be configured similar to speakers 402, 404 to include a dual magnetic driver and at least one tweeter or a tweeter cluster. In a further embodiment, the illustrated speakers 502, 504, 506, 508, 510 may be any combination of drivers and/or speakers including the dual magnetic driver and at least one tweeter.

By combining the above dual magnetic driver and inward firing tweeter cluster in a speaker unit in, for example, a stereo system, or a 5.1 surround system, the result is a speaker system that emit sound in a 360 degree, omni directional pattern. A listener can be placed in any location and can move around without noticing any change of the quality of sound. Furthermore, the sound stage is stable for the listener to appreciate and identify the position of the instruments, singers, and such.

It is to be appreciated that the various features shown and described are interchangeable, that is a feature shown in one embodiment may be incorporated into another embodiment.

Although the disclosure herein has been described with reference to particular illustrative embodiments, it is to be understood that these embodiments are merely illustrative of the principles and applications of the present disclosure. Therefore numerous modifications may be made to the illustrative embodiments and other arrangements may be devised without departing from the spirit and scope of the present disclosure, which is defined by the appended claims.

What is claimed is:

1. A loudspeaker driver comprising:
an acoustical diaphragm;
a connection tube having a first section near a first end of the connection tube, a second section near a second end of the connection tube, and a middle section between the first section and second section;
a first voice coil connected to and surrounding at least a portion of the first section of the connection tube, the first voice coil having a first audio lead and a second audio lead;
a second voice coil connected to and surrounding at least a portion of the second section of the connection tube, the second voice coil having a first audio lead and a second audio lead;
a first magnet assembly configured to suspend the first voice coil in a first magnetic field; and
a second magnet assembly configured to suspend the second voice coil in a second magnetic field;
wherein the connection tube intersects the acoustical diaphragm and the middle section of the connection tube is connected to the acoustical diaphragm.

2. The loudspeaker driver of claim 1, wherein the first magnet assembly comprises a first permanent magnet and the second magnet assembly comprises a second permanent magnet.

3. The loudspeaker driver of claim 2, wherein the first permanent magnet is a ring magnet positioned around the first voice coil and the second permanent magnet is a ring magnet positioned around the second voice coil.

4. The loudspeaker driver of claim 1, wherein the first magnet assembly and second magnet assembly comprise alignment structures configured to enable the connection tube to move along a substantially axial direction.

5. The loudspeaker driver of claim 1, wherein the first voice coil and second voice coil are configured to simultaneously receive electrical signals causing the first voice coil and second voice coil to create cooperative forces on the connection tube, thereby causing the connection tube to move back and forth along the substantially axial direction.

6. The loudspeaker driver of claim 1, wherein the acoustical diaphragm is substantially planar when at rest.

7. The loudspeaker driver of claim 1, wherein the acoustical diaphragm has a circular shape.

8. The loudspeaker driver of claim 1, further comprising a frame, wherein the frame is configured to support the first magnet assembly and second magnet assembly and maintain a predetermined distance between the first magnet assembly and second magnet assembly.

9. The loudspeaker driver of claim 8, further comprising a ring suspension configured to connect an edge of the acoustical diaphragm with the frame.

10. The loudspeaker driver of claim 8, wherein the frame comprises at least one hole to expose the acoustical diaphragm to the environment.

11. The loudspeaker driver of claim 1, wherein the first audio lead of the first voice coil is coupled to the first audio lead of the second voice coil and the second audio lead of the first voice coil is coupled to the second audio lead of the second voice coil.

12. A loudspeaker system comprising:
a plurality of drivers, each driver including a front face, a rear face, and an axis of symmetry extending substantially perpendicularly through both the front face and the rear face, each driver configured to emanate low frequency and high frequency sound waves from its front face substantially along its axis of symmetry;
each of the plurality of drivers including
an acoustical diaphragm;
a connection tube having a first section near a first end of the connection tube, a second section near a second end of the connection tube, and a middle section between the first section and second section;
a first voice coil connected to and surrounding at least a portion of the first section of the connection tube, the first voice coil having a first audio lead and a second audio lead;
a second voice coil connected to and surrounding at least a portion of the second section of the connection tube, the second voice coil having a first audio lead and a second audio lead;
a first magnet assembly configured to suspend the first voice coil in a first magnetic field; and
a second magnet assembly configured to suspend the second voice coil in a second magnetic field;
wherein the connection tube intersects the acoustical diaphragm and the middle section of the connection tube is connected to the acoustical diaphragm; and
a support structure having an inner volume, the support structure configured to support the drivers in an arrangement such that the front face of each of the drivers is directed toward the inner volume and the axis of symmetry extending from the front face of each of the drivers intersects a relatively small volume at or near a central point located at the center of the inner volume;
wherein a listening area is outside of the inner volume of the support structure.

13. The loudspeaker system of claim 12, wherein the support structure is configured to support the drivers in a substantially spherical shape.

14. The loudspeaker system of claim 12, wherein the support structure is configured to support the drivers in a substantially hemispherical shape.

15. The loudspeaker system of claim 12, further comprising an inert ball disposed in the inner volume to reduce resonance.

16. The loudspeaker system of claim 12, further comprising a muffler disposed on the rear face of each of the plurality of drivers.

17. A loudspeaker system comprising:
at least two speakers, each of the at least two speakers including:
a driver comprising:
an acoustical diaphragm;
a connection tube having a first section near a first end of the connection tube, a second section near a second end of the connection tube, and a middle section between the first section and second section;
a first voice coil connected to and surrounding at least a portion of the first section of the connection tube, the first voice coil having a first audio lead and a second audio lead;
a second voice coil connected to and surrounding at least a portion of the second section of the connection tube, the second voice coil having a first audio lead and a second audio lead;
a first magnet assembly configured to suspend the first voice coil in a first magnetic field; and
a second magnet assembly configured to suspend the second voice coil in a second magnetic field;
wherein the connection tube intersects the acoustical diaphragm and the middle section of the connection tube is connected to the acoustical diaphragm; and
at least one tweeter.

18. The loudspeaker system of claim 17, wherein the at least one tweeter includes an inward firing tweeter cluster.

19. The loudspeaker system of claim 18, wherein the plurality of speakers include a left channel speaker and a right channel speaker.

20. The loudspeaker system of claim 17, wherein the plurality of speakers include at least one front left channel speaker, at least one rear left channel speaker, at least one front right channel speaker and at least one rear right channel speaker.
